(19) United States
(12) Patent Application Publication
(10) Pub. No.: US 2024/0383668 A1
(43) Pub. Date: Nov. 21, 2024

(54) A SPRAY GUN

(71) Applicant: Samural 2K Aerosol Sdn. Bhd., Skudai (MY)

(72) Inventor: YOKE EN ONG, SKUDAI (MY)

(73) Assignee: Samural 2K Aerosol Sdn. Bhd., Skudai (MY)

(21) Appl. No.: 18/693,884

(22) PCT Filed: Oct. 25, 2021
(86) PCT No.: PCT/MY21/50094

§ 371 Date: Mar. 20, 2024

(30) Foreign Application Priority Data
Sep. 30, 2021 (MY) PI 2021005848

(51) Int. Cl. B65D 83/20

(52) U.S. Cl. CPC B65D 83/202

(57) ABSTRACT

The present invention discloses a spray gun for use with one or more aerosol containers, comprising a trigger assembly (20) pivotal with respect to a handle grip (30), wherein the trigger assembly (30) is adapted to activate a spray valve of the one or more aerosol containers when actuated with either or both a finger and a palm of a user's hand, in which direction of spray is generally away from the user.

### FIELD OF INVENTION

The present invention relates to a spray gun, more particularly, a spray gun for use with one or more aerosol containers which can be dispensed concurrently upon actuation.

### BACKGROUND OF THE INVENTION

Several designs for spray paint tools have been designed in the past. Many spray guns have been introduced which connects an aerosol container to a hand-held apparatus with a trigger assembly for actuating said aerosol container, in which the trigger is usually activated with the user's fingers. Prolonged use may lead to fatigue in the fingers, subsequently causing inconsistencies in spraying the content from the aerosol container. It is uncommon for spray guns to be able to accommodate for more than one aerosol containers. For the ones that do, the spray content from the aerosol containers are typically redirected from the aerosol containers into a singular tube, prior to being dispensed in one spray. Especially for spray paint, the spray content is mixed in the one tube before being dispensed out from the spray gun, which causes a colour mix as a result. There is no spray gun that is capable of optimising a mixing of spray content, particularly in terms of colour, when the fluid is already dispensed out from the aerosol container.

A United States patent with publication no. U.S. Pat. No. 9,814,227B2 discloses a fluid spray apparatus which includes an inlet and a first and a second outlet, in which a first actuator and a second actuator may communicate with at least one of the outlets respectively. A passage network of the fluid spray apparatus communicates with the first and second actuators with the first and second outlets. Further, a diverter structure is disposed in the passage network for causing the first actuator to communicate with the first outlet and the second actuator to communicate with the second outlet. Another United States patent with publication no. US20140239094A1 describes an adjustable dual spraying device comprising a device body including a handle, a trigger, a first solution passage configured to draw a first solution from a first chamber when the first chamber is pressurized, a second solution passage configured to draw a second solution from a second chamber when the second chamber is pressurized, a valve core coupled with an adjustment knob, a valve core coupled with an adjustment knob, an output solution passage configured to carry an output solution, and a nozzle assembly coupled with the output solution passage. A technology as disclosed in a Chinese patent with publication no. CN1313214C discloses an automatic bicomponent spraying device which comprises a spray gun, wherein the spray gun is connected with a material guide pipe which is arranged on a material storage tank. The automatic bicomponent spraying device is connected with a spray head, a gun body and a handle, two material mixing bins and material mixing balls in the two material mixing bins are arranged in the spray head, and a device for controlling the material flow rate and the material flow ratio is arranged on the handle. Yet another Chinese patent with publication no. CN101722119B discloses a double-spray-head spray gun comprising a pot body internally provided with a partition board dividing the pot body into two coating pots, in which the coating pots are internally provided with coating switches connected with a lever seat on a handle through a control lever. Further provided are two spray head main bodies corresponding to the two coating pots, the spray head main bodies are arranged at the bottom of the coating pots, in which front ends of the spray head main bodies are provided with spray caps, and the tail ends are provided with coating regulating knobs.

### SUMMARY OF INVENTION

An object of the present invention is to provide a more efficient means of spraying on a target surface in which at least two aerosol cans are able to be actuated simultaneously in operation. Another object of the present invention is to optimize mixing of content from the aerosol containers when said aerosol containers are angled accordingly. Yet another object of the present invention is to provide a more stable attachment or assembly which uses a trigger which can be actuated by a user's palm.

It is an aspect of the present invention to provide a spray gun for use with one or more aerosol containers, comprising a trigger assembly pivotal with respect to a handle grip, wherein the trigger assembly is adapted to activate a spray valve of the one or more aerosol containers when actuated by either or both a finger and a palm of a user's hand, in which direction of spray is generally away from the user.

Preferably, the trigger assembly comprises one or more receptacles at a front end portion of the assembly which is adapted to dock the aerosol containers, wherein the receptacle has a front opening to allow spraying of content from the aerosol containers.

Preferably, the trigger assembly comprises a lateral extension at the front end portion of the assembly such that two receptacles are located at two ends of the lateral extension respectively.

Preferably, the receptacle includes a receiving opening formed on either or both an upper end and a lower end of said receptacle for docking the aerosol containers.

Preferably, the receptacle having the receiving opening formed on its upper end, is upwardly or downwardly angled in an angle ranging from 0° to 30° with respect to a horizontal axis of a top part of a body of the spray gun, such that an angle of spraying is parallel to said body.

Preferably, the receptacle having the receiving opening formed on its lower end is perpendicular to the body of the spray gun.

Preferably, the receptacle further includes an aperture disposed on either a right side or a left side of said receptacle to allow access for adjusting the spray valve of the aerosol container.

Preferably, the trigger assembly comprises a trigger body which is formed by a first portion and a second portion for receiving a force exerted by the palm of the user's hand and the user's fingers respectively, to trigger either the first portion or the second portion through moving the trigger assembly from an original position to an actuating position, a third portion for actuating the spray valve of the aerosol container when the trigger assembly is at the actuating position, and a fourth portion disposed adjacent to the trigger body for returning the trigger assembly to the original position.

Preferably, the first portion and the second portion are detachably attached to the trigger assembly.

Preferably, the third portion is configured to rotate about a pivot point and move either upwards or downwards to actuate the spray valve of the aerosol containers upon triggering either or both the first portion and the second portion.

Preferably, the fourth portion is a resilient member which is configured to provide a substantial amount of resistance when either or both the first portion and the second portion receives the force through being pushed or pulled inwards, and return the trigger assembly to its original position after the force exerted onto either or both the first portion and the second portion are released.

Preferably, the handle grip includes an extrusion disposed perpendicularly with respect to the trigger assembly for receiving the user's fingers when the handle grip is held.

One skilled in the art will readily appreciate that the present invention is well adapted to carry out the objects and obtain the ends and advantages mentioned, as well as those inherent therein. The embodiment described herein is not intended as limitations on the scope of the invention.

### BRIEF DESCRIPTION OF THE DRAWINGS

For the purpose of facilitating an understanding of the invention, there is illustrated in the accompanying drawings the preferred embodiments from an inspection of which when considered in connection with the following description, the invention, its construction and operation and many of its advantages would be readily understood and appreciated.

FIG. 1 illustrates a preferred embodiment of a spray gun for use with one or more aerosol containers.

FIG. 2 illustrates a cross sectional view of the spray gun.

FIG. 3 illustrates an alternative embodiment of the spray gun.

FIG. 4 illustrates an isometric view of the alternative embodiment of the spray gun.

### DETAILED DESCRIPTION OF THE INVENTION

Hereinafter, the invention shall be described according to the preferred embodiments of the present invention and by referring to the accompanying description and drawings. However, it is to be understood that limiting the description to the preferred embodiments of the invention is merely to facilitate discussion of the present invention and it is envisioned that those skilled in the art may devise various modifications without departing from the scope of the appended claim.

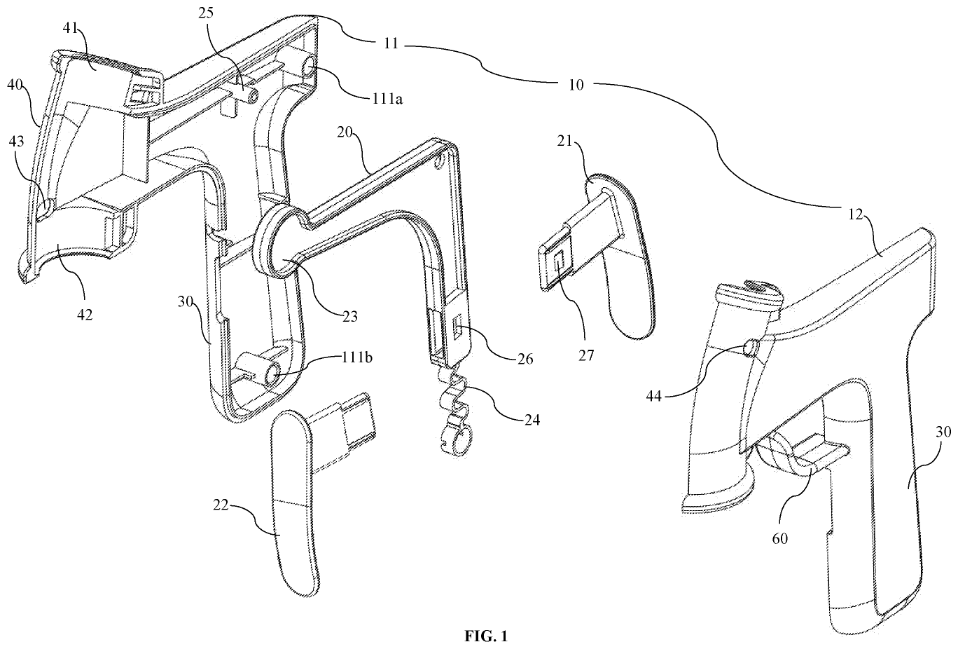

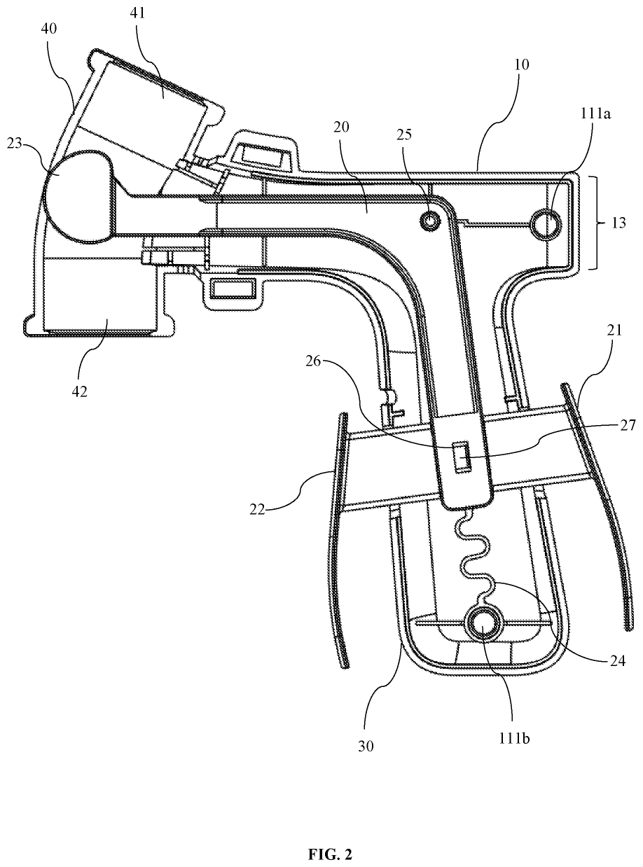

FIG. 1 illustrates a preferred embodiment of a spray gun for use with one or more aerosol containers, the spray gun comprising a trigger assembly 20 pivotal with respect to a handle grip 30, wherein the trigger assembly 30 is adapted to activate a spray valve of the one or more aerosol containers when actuated by either or both a finger and a palm of a user's hand, in which direction of spray is generally away from the user. In a preferred embodiment, the spray gun comprises a body 10 or a shell formed with a first section 11 and a second section 12 correspondingly connected to each other by means of either being pressed fit together or secured with screws. The first section 11 may include a plurality of hollow tubes 111a, 111b in its interior coinciding with a plurality of cylindrical extrusions [not shown] in the second section 12 to facilitate assembly of the body 10 of the spray gun. Preferably, the body 10 of the spray gun may be made of a material which is light and strong, such as plastic, resin, or the likes. In addition, the handle grip 30 extends downwardly at an angle from a top part 13 of the body 10 and may be designed to have an ergonomic configuration for the user to hold with a single hand easily, such as illustrated in FIG. 2. Preferably, the top part 13 of the body 10 may be typically rectangular in shape with the handle grip 30 extending from a lower part of the body. In a preferred embodiment, the handle grip 30 includes a substantially J-shaped extrusion 60 which is disposed perpendicularly on an opposite end of the handle grip 30 away from the user, such that the extrusion 60 functions to receive the user's fingers when the handle grip 30 is held. Preferably, the extrusion 60 is attached to the second section 12 of the body 10 and fits into a slot on the first section 11 when both sections 11, 12 are assembled accordingly.

In a preferred embodiment, the trigger assembly 20 comprises one or more receptacles 40 at a front end portion of the assembly 20 which is adapted to dock the aerosol containers, wherein the receptacle 40 has a front opening to allow spraying of content from the aerosol containers. The receptacle 40 includes a circumferential wall which defines a space for receiving or docking of the aerosol containers and includes a receiving opening 41, 42 formed on either or both an upper and a lower end of said receptacle 40 for docking the aerosol containers. Preferably, the receiving opening 41, 42 has an inner diameter which is smaller than an outer diameter of the circumferential wall, such that the receptacle 40 may be secured to the aerosol container. Also preferably, the upper end and the lower end of the receptacle 40 which receives the aerosol container has a substantially greater thickness as compared to the thickness of the circumferential wall. Further, the receptacle 40 further includes an aperture 43, 44 disposed on either a right side or a left side of said receptacle 40 to allow access for adjusting the spray valve of the aerosol container, more particularly for adjusting a volume of content being sprayed out from the aerosol container.

In a preferred embodiment, the receptacle 40 having the receiving opening 41 formed on its upper end is upwardly or downwardly angled in an angle ranging from 0° to 30° with respect to a horizontal axis of a top part 13 of the body 10 of the spray gun, such that the angle of spraying is parallel to said body 10. Preferably, the angle of the receptacle 40 is between 5° to 25°, such that the receiving opening 41 is on a plane that is pointing upwards and the aerosol container may be docked into said receptacle 40 in a direction towards the user, as illustrated in FIG. 1 to FIG. 4. Besides that, the receptacle 40 having the receiving opening 42 formed on its lower end may be perpendicular to the body 10 of the assembly. Alternatively, the receptacle 40 with the receiving opening 42 on its lower end may be downwardly angled in an opposite vertical direction with similar angles ranging from 0° to 30°, and more preferably 5° to 25° with respect to the horizontal axis of the top part 13 of the body 10 of the spray gun, such that the receiving opening 42 is on a plane that is pointing downwards. Such a configuration for the receptacle 40 having the receiving opening 41, 42 on both the upper end and lower end allows for a direction of the spray to be parallel to the horizontal axis of the top part 13 of the body 10 of the spray gun, and for deeper angles to be achieved without compromising ergonomics of the spray gun when in use.

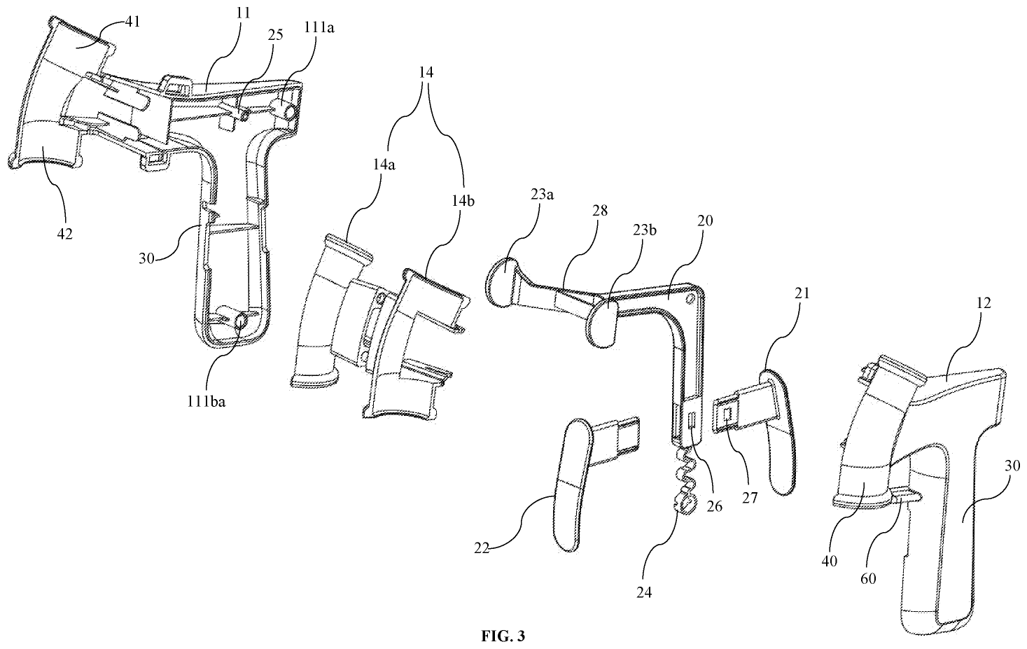

In a preferred embodiment, the trigger assembly 20 comprises a trigger body which is formed by a first portion 21 and a second portion 22 for receiving a force exerted by the palm of the user's hand and the user's fingers respectively, to trigger either the first portion 21 or the second portion 22 through moving the trigger assembly 20 from an original position to an actuating position, a third portion 23 for actuating the spray valve of the aerosol container when the trigger assembly 20 is at the actuating position, and a fourth portion 24 disposed adjacent to the trigger body for returning the trigger assembly 20 to the original position. In a particular embodiment, the third portion 23 is configured to rotate about a pivot point 25 which is located at an end of the third portion 23 opposite to an end which actuates the spray valve of the aerosol container. As shown in FIG. 1 and FIG. 3, the first portion 21 and the second portion 22 are detachably attached to the trigger assembly 20 through a snap-fit connection between a locking point 26 and an outwardly extended protrusion 27 on either or both the first portion 21 and the second portion 22, such that this provides flexibility on a number of aerosol containers to be used, whether the aerosol containers are to be docked on either or both the upper end and lower end of the receptacle 40. Such a configuration allows for either the first portion 21 or the second portion 22 to be snap-fitted to the locking point 26 of the trigger assembly 20. Besides that, the third portion 23 has a rounded shape and is disposed in between the upper end and the lower end of the receptacle, in which the position of the third portion 23 is on a central horizontal axis with respect to the pivot point 25. Advantageously, the rounded shape of third portion 23 facilitates a higher precision of actuation of the spray valve of the aerosol container when said third portion 23 is moved either upwards or downwards upon triggering either or both the first portion 21 and the second portion 22. This is due to the rounded shape of the third portion 23 corresponding to the shape of the spray valve.

In the original position, the first portion 21 protrudes from a rear section of the handle grip 30 facing the user, whereas the second portion 22 protrudes from a front section of the handle grip 30 in a direction away from the user. The third portion 23 is at a position parallel to the horizontal axis of the top part 13 of the body 10 of the spray gun, whereas the fourth portion 24 extends downwardly towards one of the hollow tubes 111b where the fourth portion 24 is attached to. In the actuating position, when the first portion 21 is triggered by the force exerted from the user's palm, the third portion 23 is then configured to rotate about the pivot point 25 in a clockwise rotation and moves upwards to actuate the spray valve of the aerosol container, subsequently spraying content from said aerosol container. When the second portion 22 is triggered by the force exerted from the user's fingers, the third portion 23 is then configured to rotate about the pivot point 25 in a counter-clockwise rotation and moves downwards to actuate the spray valve of the aerosol container. Concurrently, the fourth portion 24 being a resilient member, is configured to provide a substantial amount of resistance when either or both the first portion 21 and the second portion 22 receives the force through being pushed or pulled inwards. When the force exerted to either or both the first portion 21 and the second portion 22 is released, the fourth portion 24 returns the trigger assembly 20 to its original position. Advantageously, the spray valve of the aerosol container may be actuated with minimal force due to an increased surface area acting upon the first portion 21, which then allows the spraying of content to be more stable and accurate. Further, if the aerosol container that is actuated by triggering the first portion 21 runs out of content, the user may then trigger the second portion 22 to actuate another aerosol container as a back-up or vice versa.

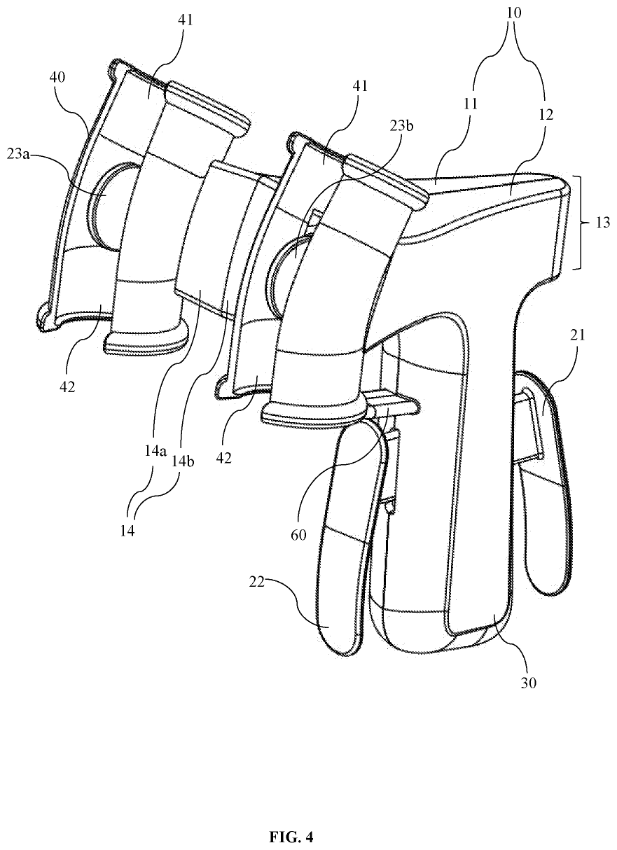

In a further embodiment, the body 10 of the spray gun further comprises a third section 14 disposed in between the first section 11 and the second section 12, wherein the third section 14 further comprises two additional sections, a left section 14a and a right section 14b which may be press fitted together to form the third section 14. In this aspect of the present invention, the trigger assembly 20 further comprises a lateral extension 26 at the front end portion of the assembly 20 such that two receptacles 40 are located at two ends of the lateral extension 28 respectively, such as illustrated in FIG. 3 and FIG. 4. For example, the spray gun may accommodate a use of up to four aerosol containers in one spraying session. The aerosol containers docked in the receptacles 40 on the ends of the lateral extension 28 may be rotatable on their radial axis to further adjust the angle of spraying along a horizontal plane. This, in turn, not only further increases a surface area for spraying the content onto the surface of an object, but also optimises a mixing efficiency of the content, particularly colour mixing for example but not limited to, a gradient colour result, when the aerosol containers are rotated towards each other such that an intersection point or overlap is formed from the spray direction. In this further embodiment, the spray valves of the aerosol containers are actuated in a similar manner, whereby the third portion 23 is configured to rotate about the pivot point 25 in the clockwise rotation when the first portion 21 is triggered by the force exerted from the user's palm, and also configured to rotate about the pivot point 25 in the counter-clockwise rotation when the second portion 22 is triggered by the force exerted from the user's fingers. In this embodiment, the third portion 23 actuates at least two aerosol containers simultaneously docked on either or both the upper end and the lower end of the receptacles 40 throughout operation.

The present disclosure includes as contained in the appended claims, as well as that of the foregoing description. Although this invention has been described in its preferred form with a degree of particularly, it is understood that the present disclosure of the preferred form has been made only by way of example and that numerous changes in the details of construction and the combination and arrangements of parts may be resorted to without departing from the scope of the invention.

1.-12. (canceled)

13. A spray gun for use with one or more aerosol containers, comprising:
a handle grip for a user to hold the spray gun; and
a trigger assembly that enables a direction of spray generally away from the user, which is pivotal with respect to the handle grip, having a trigger body formed by one or more portions that include a first portion, a second portion, and a third portion;
wherein the first portion and the second portion of the trigger assembly each are at opposing sections of the handle grip, and they respectively enable movement of the third portion for activating spray valves of the aerosol containers when either the first portion is triggered by a palm of the user's hand for the third portion to move in an upwards direction to activate corresponding spray valves of the aerosol containers, or the second portion is triggered by fingers of the user's hand for the third portion to move in a downwards direction to activate corresponding spray valves of the aerosol containers.

14. The spray gun according to claim 13, further comprising one or more receptacles at a front end portion of a body of the spray gun which is adapted to dock the aerosol containers, wherein the receptacle has a front opening to allow spraying of content from the aerosol containers.

15. The spray gun according to claim 14, further comprising a lateral extension at the front end portion of the body of the spray gun such that two receptacles are located at two ends of the lateral extension respectively.

16. The spray gun according to claim 15, wherein the receptacle includes a receiving opening formed on either or both an upper and a lower end of said receptacle for docking the aerosol containers.

17. The spray gun according to claim 16, wherein the receptacle having the receiving opening formed on its upper end is upwardly or downwardly angled in an angle ranging from 0° to 30° with respect to a horizontal axis of a top part of the body of the spray gun, such that angle of spraying is parallel to said body.

18. The spray gun according to claim 17, wherein the receptacle having the receiving opening formed on its lower end, is perpendicular to the body of the spray gun.

19. The spray gun according to claim 18, wherein the receptacle further includes an aperture disposed on either a right side or a left side of said receptacle to allow access for adjusting the spray valve of the aerosol container.

20. The spray gun according to claim 13, wherein the trigger assembly is movable from an original position to an actuating position when its first portion receives a force exerted by the palm of the user's hand or when its second portion receives a force exerted by fingers of the user's hand, and in the actuating position, the third portion activates spray valve of the aerosol container; and
movable from the actuating position to the original position through its fourth portion disposed adjacent to the trigger body for returning the trigger assembly to the original position.

21. The spray gun according to claim 13, wherein the first portion and the second portion are detachably attached to the trigger assembly.

22. The spray gun according to claim 13, wherein the third portion is configured to rotate about a pivot point and move either upwards or downwards to actuate the spray valve of the aerosol containers upon triggering either or both the first portion and the second portion.

23. The spray gun according to claim 20, wherein the fourth portion is a resilient member which is configured to provide a substantial amount of resistance when either or both the first portion and the second portion receives the force through being pushed or pulled inwards, and return the trigger assembly to its original position after the force exerted onto either or both the first portion and the second portion are released.

24. The spray gun according to claim 13, wherein the handle grip includes an extrusion disposed perpendicularly with respect to the trigger assembly for receiving the user's fingers when the handle grip is held.
